(19) United States
(12) Patent Application Publication
(10) Pub. No.: US 2006/0136437 A1
(43) Pub. Date: Jun. 22, 2006

(54) System, method and program for distributed policy integration

(76) Inventor: Yasushi Yamasaki, Higashiyamato (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/060,485

(22) Filed: Feb. 18, 2005

(30) Foreign Application Priority Data
Dec. 21, 2004 (JP) 2004-368645

(51) Int. Cl. G06F 7/00

(52) U.S. Cl. 707/100

(57) ABSTRACT

A distributed policy linking method is provided which performs a policy based management according to a plurality of pieces of policy information distributed in a plurality of domains. A policy configuration management system is installed which manages a set of an identifier and a policy repository for each piece of policy information stored in a plurality of policy repositories. The policy information corresponding to an event issued from a resource being managed is searched from the first policy repository. If the policy information retrieved includes an identifier representing a reference to a second policy repository, an access unit to the second policy repository is retrieved from the policy configuration management system according to the identifier. Policy information is then retrieved from the second policy repository and, based on the policy information obtained, a configuration modification operation is executed on the resource being managed.

### INCORPORATION BY REFERENCE

The present application claims priority from Japanese application JP 2004-368645 filed on Dec. 21, 2004, the content of which is hereby incorporated by reference into this application.

### BACKGROUND OF THE INVENTION

The present invention relates to a technology for a policy based management according to policy information distributed among a plurality of sites.

An IT system, which has been growing in complexity in recent years, is connected to a variety of devices, such as networks, servers and storages, to build an integrated system. Such a system including a number of component devices requires a continual maintenance and management after the system has been completed and become operational, to deal with possible failures of servers and overloads from end users. Thus, when viewed from the standpoint of a total cost of ownership (TCO) of the IT system, the cost of operation and management in addition to the cost of device procurement and lease is on the rise and cannot be neglected. Of the operation and management cost, labor costs account for a significantly large proportion and many operation and management methods have been developed for reducing the cost of labor. Operation and management software is one such example, intended to provide a function of remote control and remote surveillance on resources to be managed and also provide an integrated console to reduce a burden on the part of an administrator and therefore the labor cost and TCO. Among conventional techniques with the above function there is one which remotely monitors a variety of system resources through a standardized remote network management protocol, such as SNMP (Simple Network Management Protocol) shown in a non-patent document 1, to detect failures and troubles. Further, as in the WBEM (Web Based Enterprise Management) shown in non-patent document 2, specifications have been proposed to manage system resources through the Web with an emphasis placed on simplifying the operation and management.

However, such a remote observation and control system as represented by the above-described SNMP still requires an intervention on the part of an administrator for operation and management. This means that the know-how of this system is integrated with humans and is therefore difficult to put to future re-use. That is, although the conventional system can reduce the workload of the administrator, what the administrator must take into account spans an almost entire range of resources to be managed, putting a limitation on labor reduction.

To deal with this problem, a technology called a policy based management is being spotlighted in recent years. This method writes down the know-how that has conventionally been connected with human staffs in the form of policy information, by which the resources to be managed are controlled. Thus, this method is expected to be able to automatically perform the normal operation and management procedure and quickly cope with unexpected system troubles, resulting in a reduction in TCO cost. Examples of such a policy based management technique include JP-A-2002-111729 (corresponding U.S. patent: U.S. 2002/0040396A1 published on Apr. 4, 2002), U.S. Pat. No. 6,708,209 issued to Ebata et al on Mar. 16, 2004, and SNMP Specification (RFC1157) issued by IETF http://www.ietf.org/rfc/rfc1157.txt and WBEM Specification issued by DMTF http://www.dmtf.org/standards/wbem. Generally, policy information often adopts an IF-THEN rule which, in response to an event that occurs with the resources being managed, executes a corresponding action. More specifically, when an available storage capacity is running low, an action is executed to add a new disk device. That is, the policy based management can be considered to be a technology that performs by means of software the work that has been thought out and executed by an administrator.

In the conventional technique, when a part of policy information used for policy based management is transformed into library for possible reuse, it is necessary to bind the policy library and the policy information built by using the policy library and, at the timing of the policy based management execution, introduce them into a policy based management system. Therefore, when a part of the policy library and the policy information is changed, binding processing must be performed again on the policy information, giving rise to a problem when the policy information and policy library are maintained and managed in a plurality of management domains.

Considering these, problems to be solved by this invention may be summarized as follows.

(a) Each management domain must have and manage a policy independently.

(b) There needs to be a mechanism that records in which policy depository a policy of interest is stored.

(c) There needs to be a mechanism that describes a relation between policies distributed among a plurality of policy repositories.

### SUMMARY OF THE INVENTION

A difficulty in performing a policy based management according to distributed policy information while keeping independence among management domains of the maintenance and management of policy information lies in the fact that there is no mechanism to store relations or associations among a plurality of pieces of policy information or mechanism that allows for the application of the policy based management according to the linking information. For this reason, this invention provides a means to dynamically resolve a relation between a plurality of pieces of policy information and thereby perform the policy based management.

More specifically, the present invention provides the following methods (A)-(C) to deal with the above problems (a)-(c).

(A) A policy repository is provided for each management domain to allow for dynamic policy information inquiry.

(B) A policy configuration management system is introduced to manage an association between a policy name and a storage location.

(C) As a policy description method, a special entry is provided that represents a reference to a policy rule held in another policy repository. Using this entry, a policy is resolved.

An implementation of this invention makes it possible to perform the policy based management according to the distributed policy information while keeping independence among management domains. More specifically, the above methods (A)—(C) produce the following effects, respectively.

(1) By installing a policy repository in each management domain to allow for policy inquiry, the content of policy repository can be changed according to a decision made by the associated management domain alone. Further, when a change is made, there is no need to notify the change to other management domains. Nor does the change produce adverse effects.

(2) By providing a policy configuration management system to manage locations of the policy information, the relation between the policy information and the management domain for the policy information can be resolved when performing the policy based management, thus improving independence of policy information from management domains.

(3) By allowing the link information among policy information to be recorded, the reusability of the policy information can be enhanced.

Other objects, features and advantages of the invention will become apparent from the following description of the Embodiments of the invention taken in conjunction with the accompanying drawings.

### BRIEF DESCRIPTION OF THE DRAWINGS

FIG. 1 illustrates an overall configuration of a system in Embodiment 1.

FIG. 2 illustrates a program configuration in Embodiment 1.

FIG. 3 shows a content of a policy table in a business management domain in Embodiment 1.

FIG. 4 shows a content of a policy table in a policy provider domain in Embodiment 1.

FIG. 5 shows a content of a policy configuration management table in Embodiment 1.

FIG. 6 shows a content of a default policy table in Embodiment 1.

FIG. 7 shows a content of a configuration information management table before a policy rule is executed in Embodiment 1.

FIG. 8 shows a content of the configuration information management table after the policy rule is executed in Embodiment 1.

FIG. 9 shows a flow chart for a policy engine system in Embodiment 1.

FIG. 10 shows a content of a policy table in a business management domain in Embodiment 2.

FIG. 11 shows a content of a policy table in a policy provider domain in Embodiment 2.

FIG. 12 shows a content of a policy configuration management table in Embodiment 2.

FIG. 13 shows a flow chart for a policy engine system in Embodiment 2.

FIG. 14 shows an overall system configuration in Embodiment 3.

FIG. 15 shows a program configuration in Embodiment 3.

FIG. 16 shows a content of a policy table in a business management domain in Embodiment 3.

FIG. 17 shows a content of a policy table in a policy provider domain in Embodiment 3.

FIG. 18 shows a content of a policy configuration management table in Embodiment 3.

FIG. 19 shows a content of a default policy table in Embodiment 3.

FIG. 20 shows a content of a configuration information management table before a policy rule is executed in Embodiment 3.

FIG. 21 shows a content of the configuration information management table after the policy rule is executed in Embodiment 3.

FIG. 22 shows an overall system configuration in Embodiment 4.

FIG. 23 shows a program configuration in Embodiment 4.

FIG. 24 shows a content of a policy table in a business management domain in Embodiment 4.

FIG. 25 shows a content of a policy table in a business management parent domain in Embodiment 4.

FIG. 26 shows a content of a domain configuration management table in Embodiment 4.

FIG. 27 shows a content of a default policy table in Embodiment 4.

FIG. 28 shows a content of a configuration information management table before a policy rule is executed in Embodiment 4.

FIG. 29 shows a content of the configuration information management table after the policy rule is executed in Embodiment 3.

FIG. 30 shows a flow chart for a policy engine system of Embodiment 4.

FIG. 31 shows a policy configuration management console screen (before policy registration) in Embodiment 5.

FIG. 32 shows a policy configuration management console screen (after policy registration) in Embodiment 5.

FIG. 33 shows a domain configuration management console screen (before domain registration) in Embodiment 6.

FIG. 34 shows a policy configuration management console screen (after domain registration) in Embodiment 6.

### DETAILED DESCRIPTION OF THE EMBODIMENTS

To show that a policy based management can be performed according to policy information distributed among a plurality of policy repositories, Embodiments 1 to 7 will be described as follows. In these Embodiments, resources to be controlled under the policy based management are contemplated to be Web server computers or storage devices. They include a variety of other system resources, such as networks, middleware and operating systems, and are not limited to any particular kind of resource.

As to the system configuration and network configuration, the invention can be applied to a variety of configurations other than those shown in the Embodiments.

### Embodiment 1

In this Embodiment, an operation of a policy based management system will be described for a case in which policy rules designed to policy based-control business applications running on resources provided by a data center domain are distributed in a business management domain that manages the business applications and in a policy provider domain and in which a policy of the business management domain is delegated to the policy provider domain.

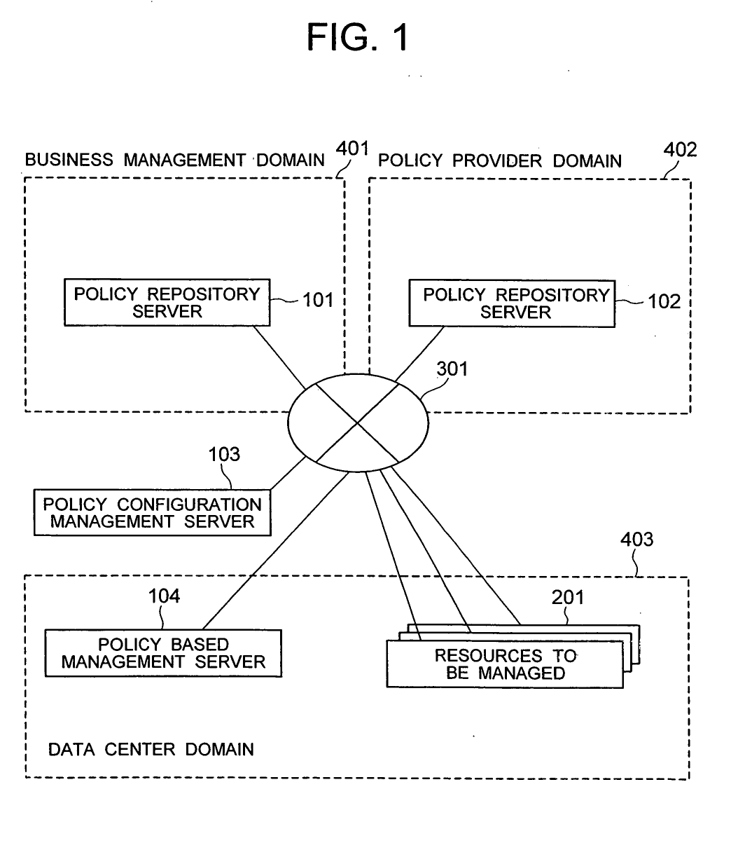

First, a configuration of a network on which the system is built and that of server computers will be described. FIG. 1 shows an overall system configuration of this Embodiment. In the business management domain 401 a policy repository server 101 is running. Similarly, in a policy provider domain 402 a policy repository server 102 is running. A policy configuration management server 103 that provides information for linking distributed policies is operating outside these domains. In a data center domain 403, policy based-managed resources 201 for running the business applications are operated and managed, and a policy based management server 104 to policy based-control these resources is also operating. In this Embodiment, it is assumed that these servers 101-104 and the resources 201 are interconnected by a single logical network 301. It is noted, however, that a physical network need not be a single network but may be divided into a plurality of sub-networks. Nor does it have to be homogeneous.

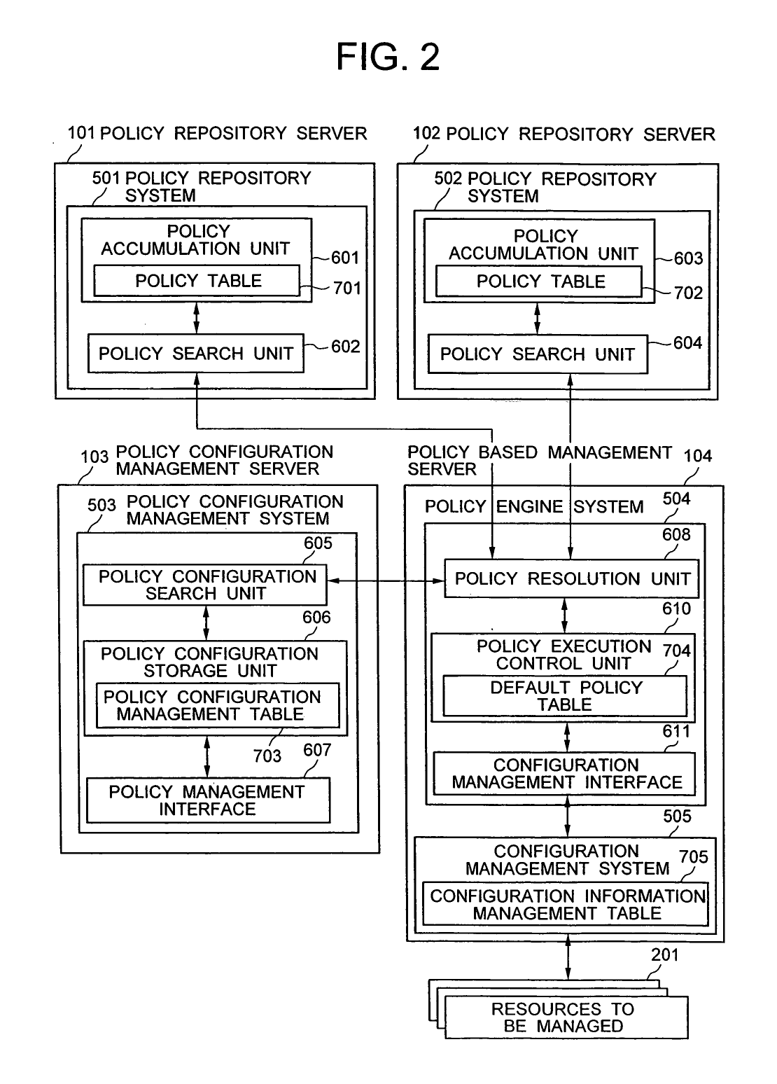

Next, a program configuration in each server will be explained by referring to FIG. 2. Operating on the policy repository server 101 in the business management domain 401 is a policy repository system 501 which includes a policy accumulation unit 601 and a policy search unit 602. Similarly, on the policy repository server 102 in the policy provider domain 402 is running a policy repository system 502 which includes a policy accumulation unit 603 and a policy search unit 604. In the policy configuration management server 103, a policy configuration management system 503 is operating which includes a policy configuration search unit 605, a policy configuration storage unit 606 and a policy management interface. On the policy based management server 104 in the data center domain 403, a policy engine system 504 and a configuration management system 505 are running. The policy engine system 504 includes a policy resolution unit 608, a policy execution control unit 610 and a configuration management interface.

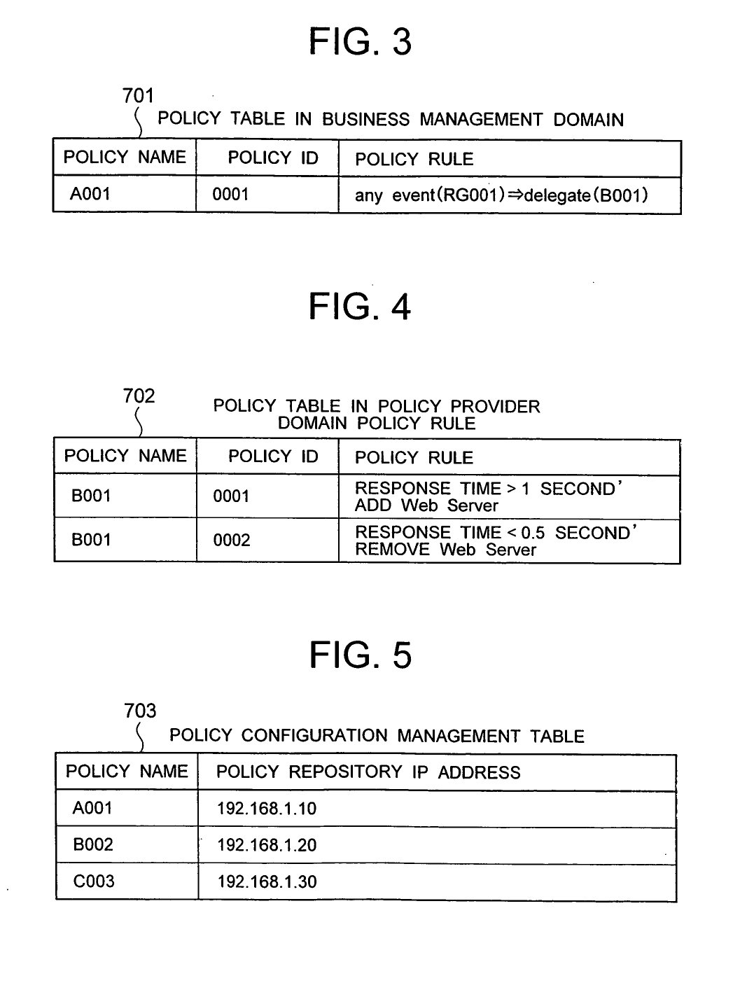

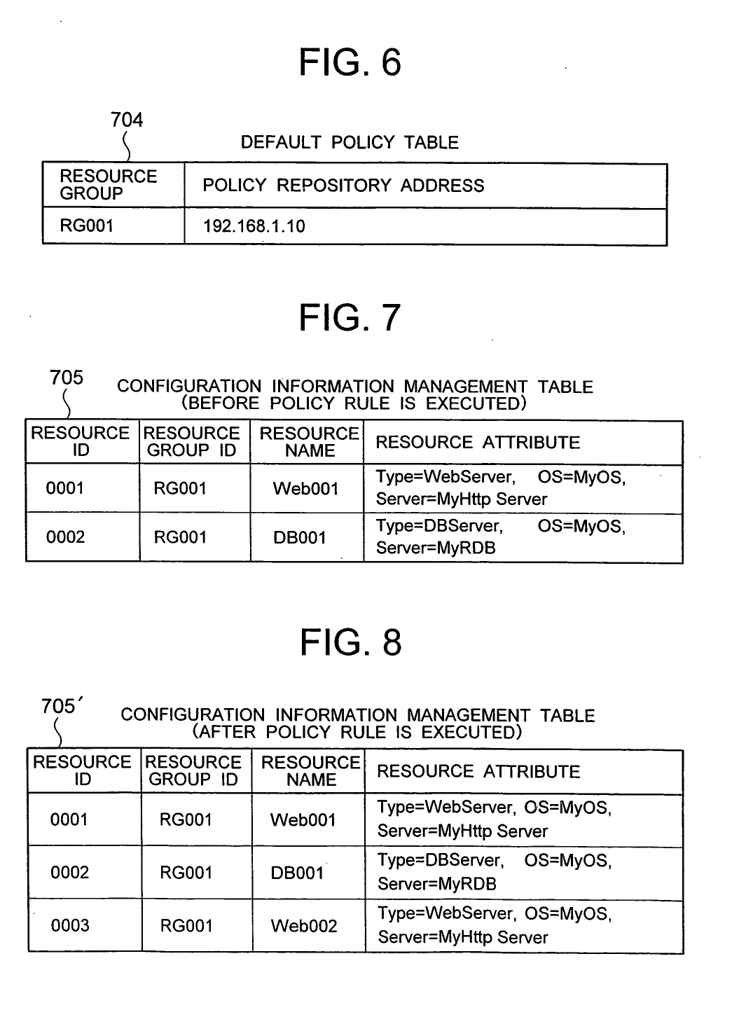

A content shown in FIG. 3 is stored in a policy table 701 managed by the policy accumulation unit 601, a content shown in FIG. 4 is stored in a policy table 702 managed by the policy accumulation unit 603, and a content shown in FIG. 5 is stored in a policy configuration management table 703 managed by the policy configuration storage unit 606. A default policy table 704 managed by the policy execution control unit 610 stores a content shown in FIG. 6. It is assumed that detailed information on the policy based-managed resources 201 in the data center domain is stored in a configuration information management table 705 of FIG. 7 managed by the configuration management system.

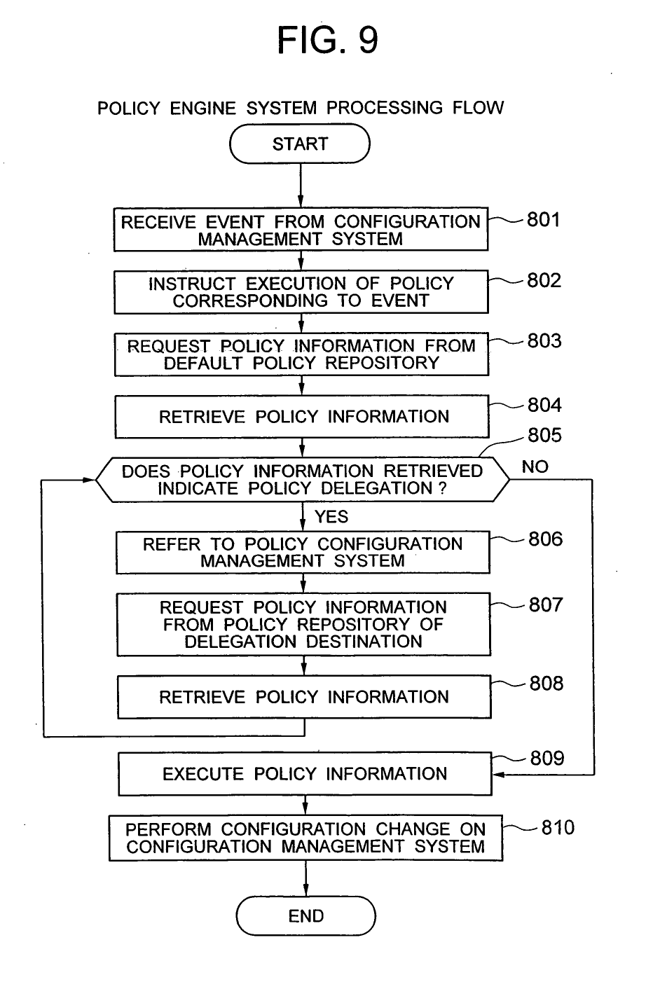

Under the above environment, processing of the policy based management will be explained by referring to a processing flow of the policy engine system 504 shown in FIG. 9. First, let us consider a case where an event message has been sent to the configuration management system 505, indicating that, of the policy based-managed resources 201 operated by business applications, a load of a Web server corresponding to a resource ID of 0001 in the configuration information management table 705 has increased, degrading a response time to more than 1 second. The event message also includes a resource group ID (see FIG. 7) that corresponds one-to-one to the business application. Further, the configuration management system 505 transfers the event message received to the policy execution control unit 610 via a configuration management interface 611 of the policy engine system 504 (step 801). The policy execution control unit 610 checks the content of the default policy table 704 to retrieve an IP address of a policy repository corresponding to the resource group ID contained in the received event message. Here, the resource group ID is RG001, so the corresponding policy repository IP address of 192.168.1.10 is retrieved.

Next, the policy execution control unit 610 requests the policy resolution unit 608 to resolve a policy rule to be executed, by using the retrieved default policy repository IP address and event message as input values. The policy resolution unit 608 then requests policy information corresponding to the event message from the policy search unit 602 of the policy repository system 501 running on the policy repository server 101 in the business management domain having the address of 192.168.1.10 (step 803). The policy search unit 602 makes a policy information search request to the policy accumulation unit 601 and returns to the policy resolution unit 608 the policy information with a policy name of A001 and a policy ID of 001 in the policy table 701 of FIG. 3 (step 804).

The policy resolution unit 608 checks that the retrieved policy information is one that indicates a delegation to a policy whose policy name is B001 (step 805). Then, to access a policy repository server that stores delegation destination policy information, the policy resolution unit 608 requests the policy configuration search unit 605 of the policy configuration management server 103 to search for a policy repository holding policy information corresponding to the policy name B001. The policy configuration search unit 605 searches through the policy configuration management table 703 of FIG. 5 and returns an address 192.168.1.20 of the policy repository server corresponding to the policy name of B002 to the policy configuration search unit 605. The policy resolution unit 608 receives the address from the policy configuration search unit 605 (step 806).

Next, the policy resolution unit 608 requests the policy search unit 604 of the policy repository system 502 running on the policy repository server 102 in the policy provider domain 402 with an address of 192.168.1.20 to search for a policy corresponding to the event message (step 807). The policy search unit 604 searches for policy information whose policy name is B001 and which corresponds to the event message that the response time has exceeded 1 second, and then returns the policy information obtained to the policy resolution unit 608. At this time, the policy information returned has a policy ID of 0001 in FIG. 4 (step 808). The policy information thus searched and obtained in the above processing is transferred to the policy execution control unit for execution (step 809). As a result, the number of Web servers is increased and the configuration management system is requested to add a Web server (step 810). The content of the configuration management table after the execution of the policy rule is as shown in FIG. 8, indicating that a Web server belonging to the resource group RG001 is added.

If it is decided that the policy information to be applied indicates a delegation to other policy information, the step 806 refers to the policy configuration management system 503 for an IP address of a policy repository having delegation destination policy information. By changing the configuration to store the IP address of the policy repository obtained through inquiry in the policy resolution unit 608, it is possible to omit the query process that would otherwise be required to be performed at each policy information retrieval. That is, the step 806 first searches through the past stored query results by the policy name of delegation destination policy information. Only when the IP address of the policy repository corresponding to the policy name is not found in the policy resolution unit 608, does the step 806 sends an inquiry to the policy configuration management system 503.

### Embodiment 2

In this Embodiment, an operation of a policy based management system will be described for a case in which policy rules designed to policy based-control business applications running on resources provided by a data center domain are distributed in a business management domain that manages the business applications and in a policy provider domain; in which a policy of the business management domain is delegated to the policy provider domain; and in which the business management domain overwrites a part of the policy with its own policy information.

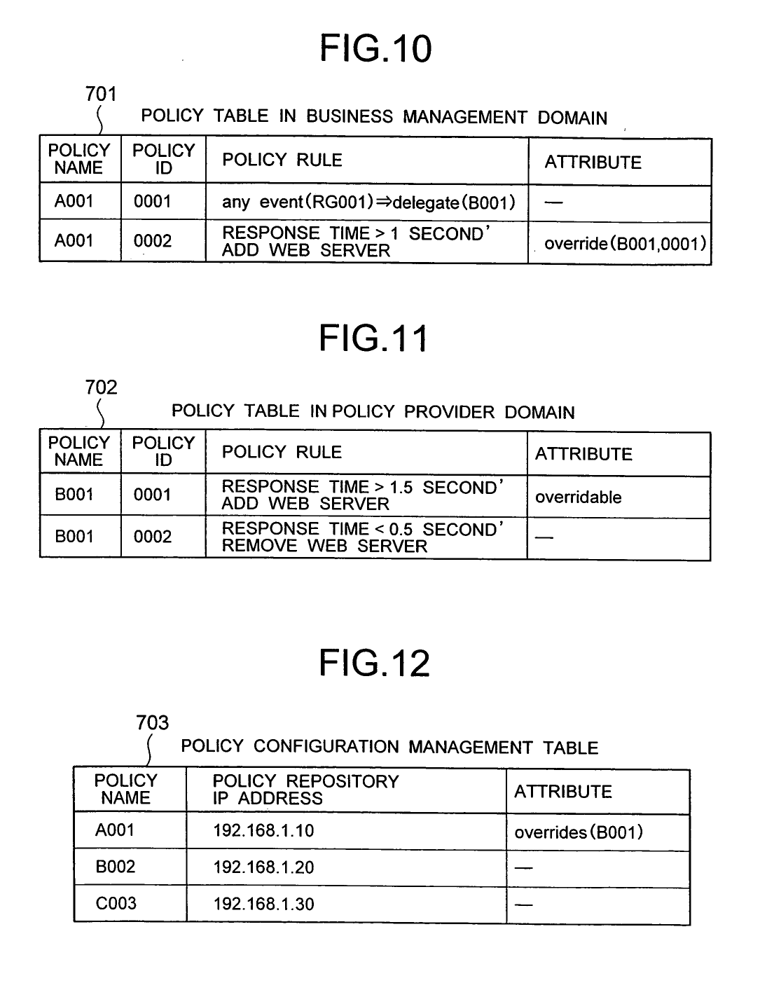

The configurations of the network and the server computers in this Embodiment are similar to those of Embodiment 1. The program configurations in the server computers are also similar to those of Embodiment 1. It is noted, however, that, as shown in FIGS. 10, 11 and 12, the policy management table held in each domain and the policy configuration management table held in the policy configuration management server are each given additional attribute columns to allow for the setting of information on the overriding relationship between policies.

As an example of setting, in the policy table 701 managed in the policy accumulation unit 601 of the business management domain a setting is made to delegate the policy related to a resource group RG001 to a policy managed in another domain and having a policy name of B001, as shown in FIG. 10 (policy ID: 0001). Further, a policy rule in this table with a policy ID of 0002 is set to override the policy rule in B001 corresponding to the policy ID of 0001 (the setting of “override (B001, 0001)” in the attribute column). In the policy table 702 managed by the policy accumulation unit 603 in the policy provider domain, the policy rule corresponding to the policy ID of 0001 in the policy name of B001 is set as being able to be overwritten with a policy of another domain, as shown in FIG. 11. Further, as shown in FIG. 12, in the policy configuration management table 703 managed by the policy configuration management server 103, a policy with a policy name of A001 held in a policy repository with an IP address of 192.168.1.10 is set to include a policy rule that overrides a policy whose policy name is B001. It is assumed that the default policy table 704 and the configuration information management table 705 store beforehand the contents shown in FIG. 5 and FIG. 6, respectively, as in Embodiment 1.

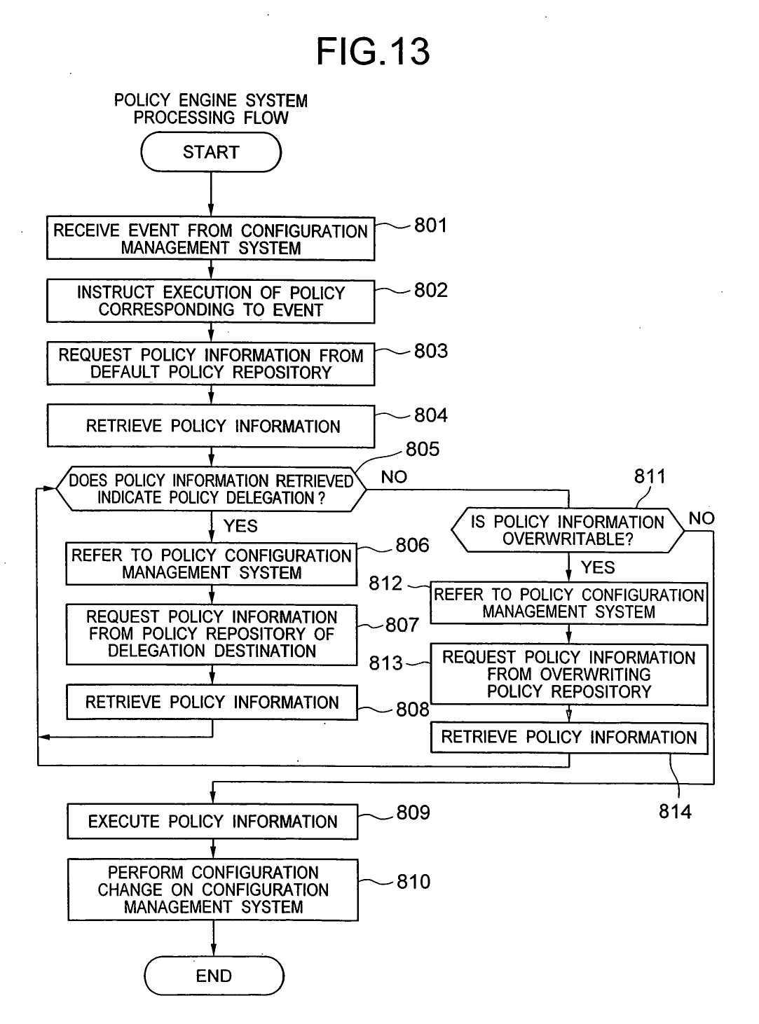

Under the above environment, an operation of the policy based management will be explained by referring to a flow of processing performed by the policy engine system 504 shown in FIG. 13. First, an event message is sent to the configuration management system 505, indicating that, among resources 201 being managed on which business applications are running, the load of a Web server corresponding to a resource ID of 0001 in the configuration information management table 705 of FIG. 7 has risen and that the response time has deteriorated to more than 1 second. Then, the policy engine system 504 performs steps 801 to 808 in a manner similar to that of Embodiment 1 to retrieve policy information with a policy ID of 0001 from the policy table 702 in the policy provider domain of FIG. 11. It is noted, however, that this policy rule is intended to add a Web server when the response time deteriorates to more than 1.5 seconds. Because the above event message is used to indicate that the response time has degraded to more than 1 second, this rule is not executed if the content of the policy table is the same as that of Embodiment 1. In this Embodiment, the policy resolution unit 608 checks whether “overridable” is set as an attribute of the policy information (step 811), indicating that the policy information can be overwritten.

Since the policy information for the policy ID of 0001 in FIG. 11 has an attribute of “overridable”, the policy resolution unit 608, in order to check whether there is policy information that overrides this policy, requests the policy configuration search unit 605 of the policy configuration management system to search for a policy name overriding the policy information of policy name B001 and for an address of a policy repository storing that policy name. Upon receiving the request, the policy configuration search unit 605 retrieves the corresponding policy name A001 and policy repository IP address 192.168.1.10 from the policy configuration management table 703 and transfers them to the policy resolution unit (step 812).

Next, according to the search result the policy resolution unit 608 retrieves the corresponding overriding policy information having a policy ID of 0002 in FIG. 10 from the policy table 701 of the policy repository server 101 in the business management domain (step 813). The policy information thus obtained by the above processing is then transferred to the policy execution control unit for execution (step 809), as in Embodiment 1. As a result, the number of Web server is increased and a request is made to the configuration management system to add a Web server (step 810). The content of the configuration management table after being executed is as shown in FIG. 8, indicating that one Web server belonging to the resource group RG001 is added as a result of executing the policy rule.

In this Embodiment also, by storing an address of the policy repository holding a delegation destination policy which is obtained as a result of step 806 referring to the policy configuration management system 503, the procedure can be changed to first make a search through the past inquiries prior to the step 806 of making an inquiry. Similarly, a procedure may be added which involves storing in the policy resolution unit 608 an overriding policy and an IP address of the policy repository holding the overriding policy which are obtained by the step 812 checking with the policy configuration management system 503. This allows the step 812 to check with the past inquiry results prior to referring to the policy configuration management system 503. If the overriding policy and the IP address of the policy repository holding the overriding policy exist in the policy resolution unit 608, it is possible to request from the policy resolution unit 608 the policy information that overrides the policy to be applied, without referring to the policy configuration management system 503.

### Embodiment 3

In this Embodiment, an operation of a policy based management system will be described for a case in which policy rules designed to policy based-control two business applications running on resources provided by two data center domains are distributed in a business management domain that manages the business applications and in a policy provider domain and in which a part of the policy of the business management domain is delegated to the policy provider domain.

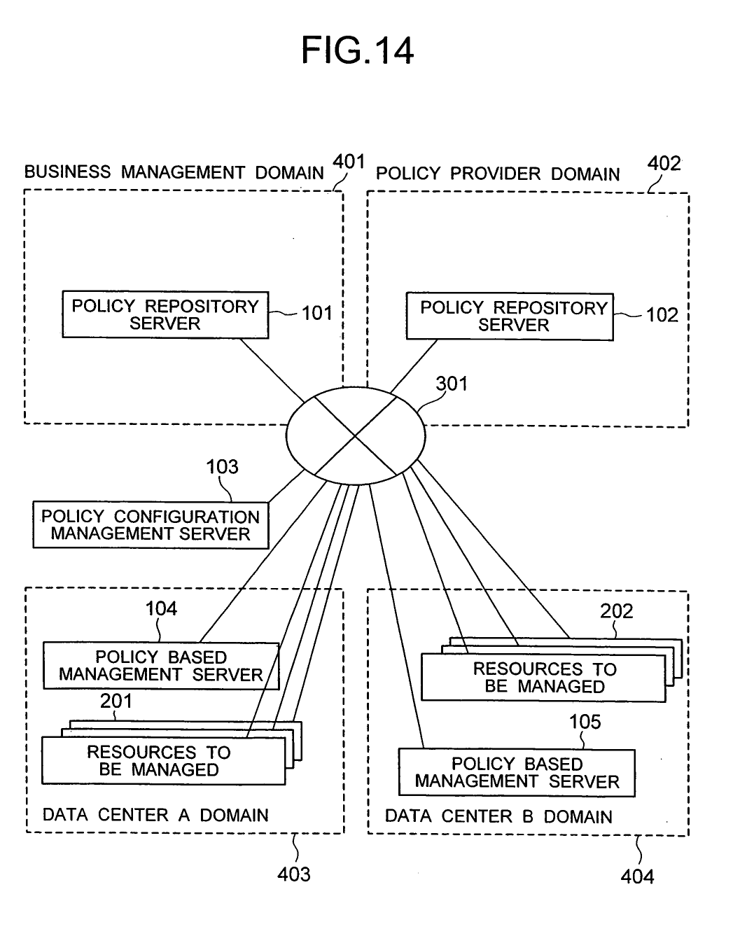

First, a configuration of a network on which the system is built and that of server computers will be described. FIG. 14 shows an overall system configuration of this Embodiment. In the business management domain 401 a policy repository server 101 is running. Similarly, in a policy provider domain 402 a policy repository server 102 is running. A policy configuration management server 103 that provides information for linking distributed policies is operating outside these domains. In a data center A domain 403, policy based-managed resources 201 for running the business applications are operated and managed, and a policy based management server 104 to policy based-control these resources are operating. Similarly, in a data center B domain 404, a policy based management server 105 and resources 202 being managed are operated. In this Embodiment, it is assumed that these servers 101-105 and resources 201, 202 are interconnected by a single logical network 301. It is noted, however, that a physical network need not be a single network but may be divided into a plurality of sub-networks. Nor does it have to be homogeneous.

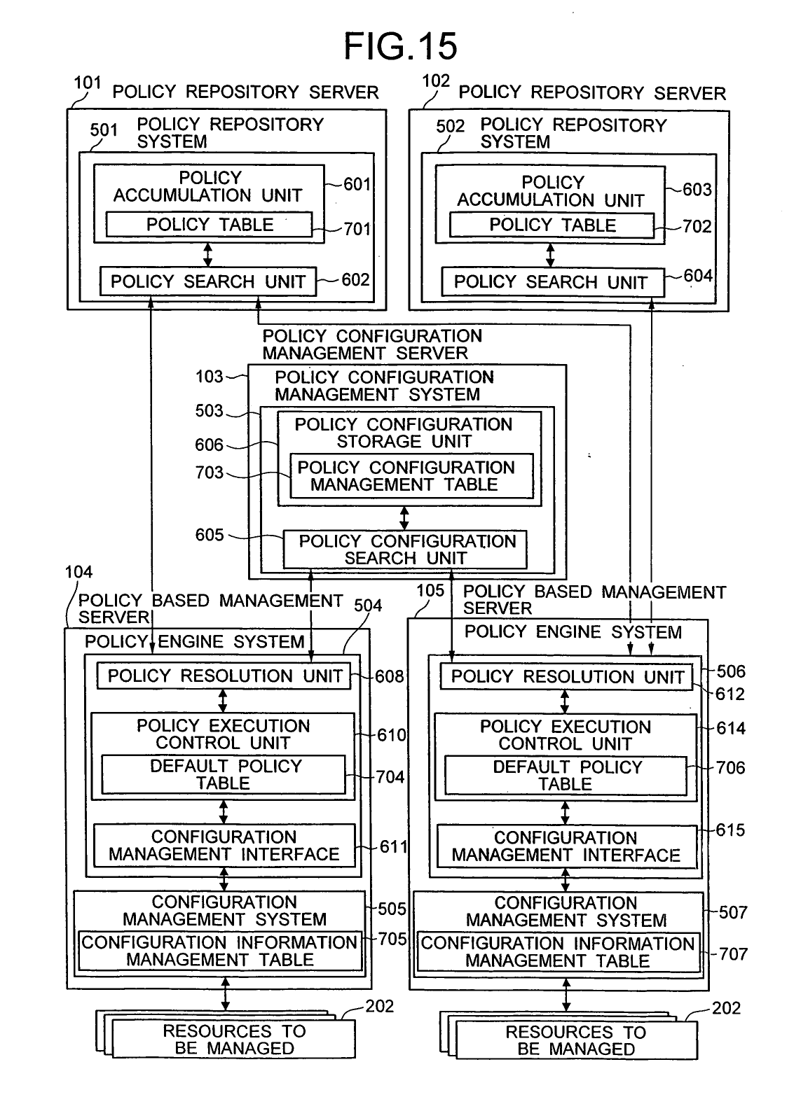

Next, a program configuration in each server will be explained by referring to FIG. 15. Operating on the policy repository server 101 in the business management domain 401 is a policy repository system 501 which includes a policy accumulation unit 601 and a policy search unit 602. On the policy repository server 102 in the policy provider domain 402 is running a policy repository system 502 which includes a policy accumulation unit 603 and a policy search unit 604. In the policy configuration management server 103, a policy configuration management system 503 is operating which includes a policy configuration search unit 605, a policy configuration storage unit 606 and a policy management interface 607. On the policy based management server 104 in the data center A domain 403, a policy engine system 504 and a configuration management system 505 are running. The policy engine system 504 includes a policy resolution unit 608, a policy execution control unit 610, and a configuration management interface 611. Similarly, on the policy based management server 105 in the data center B domain 404, a policy engine system 506 and a configuration management system 507 are operating. The policy engine system 506 includes a policy resolution unit 612, a policy execution control unit 614 and a configuration management interface unit 615.

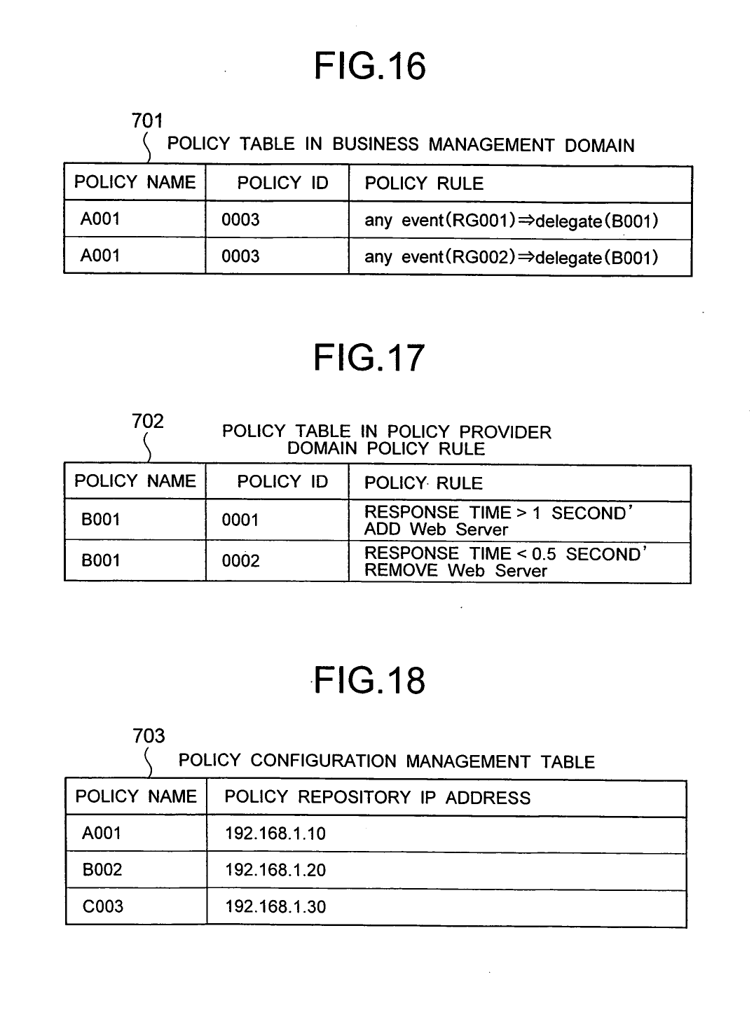

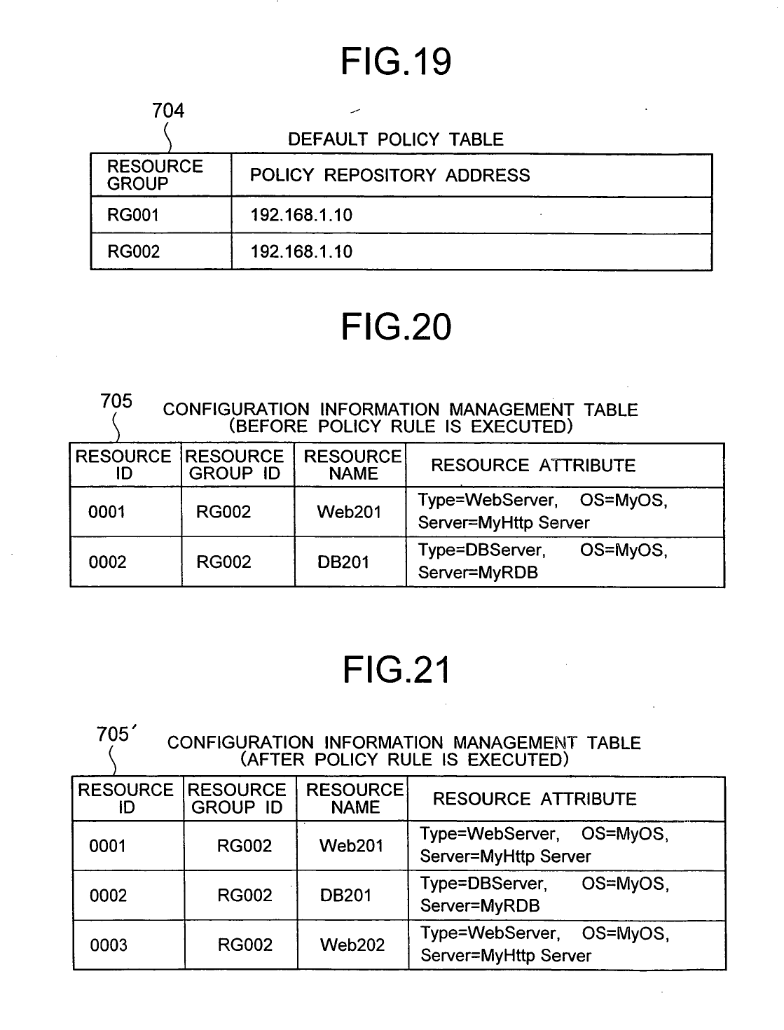

Further, a policy table 701 managed by the policy accumulation unit 601 stores a content shown in FIG. 16; a policy table 702 managed by the policy accumulation unit 603 stores a content shown in FIG. 17; a policy configuration management table 703 managed by the policy configuration storage unit 606 stores a content shown in FIG. 18; and a default policy table 704 managed by the policy execution control unit 610 stores a content shown in FIG. 19. It is assumed that information on the resources 201 to be managed in the data center A domain and on the resources 202 to be managed in the data center B domain are stored in configuration information management tables 705 shown in FIG. 7 and FIG. 20, respectively.

Under the above environment, it is assumed that the policy engine systems 504, 505 are performing policy based management according to the processing flow of the policy engine system shown in FIG. 9. When the response time of the Web server for the resources 201 being managed in the data center A domain 403 or for the resources being managed in the data center B domain 404 exceeds 1 second and an event message is issued, the similar processing to that of Embodiment 1 is executed, adding one Web server for business applications running in the data center A or data center B. The contents of the configuration information management tables 705 after the execution of the policy rule are as shown in FIG. 8 and FIG. 21.

As described above, even when there are a plurality of resources to be managed and policy engine systems, the policy based management by distributed policies as disclosed in this invention can function effectively because policy information necessary for business applications running on each of the resources being managed is retrieved and executed according to link information held in a policy configuration management server.

### Embodiment 4

In this Embodiment, an operation of a policy based management system will be explained for a case where policy rules to policy based-control business applications running on resources provided by a data center domain are distributed in a business management domain that manages the business applications and in a business management parent domain which is a parent of the business management domain. The business management parent domain is given a higher authority for the business policy based management than the business management domain.

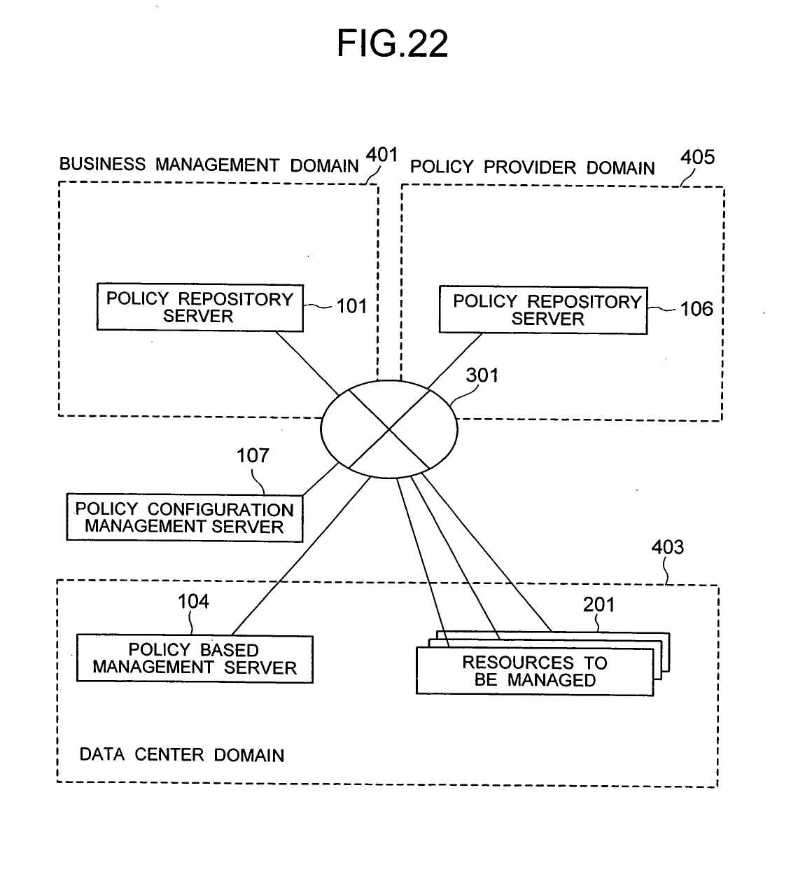

First, a configuration of a network on which the system is built and that of server computers will be described. FIG. 22 shows an overall system configuration of this Embodiment. In the business management domain 401 a policy repository server 101 is running. In a business management parent domain 405 a policy repository server 106 is running. A domain configuration management server 107 that provides information for linking these distributed policies is operating outside these domains. In a data center domain 403 policy base-managed resources 201 for running the business applications are operated and managed, and a policy based management server 104 to policy based-control these resources is also operating. In this Embodiment, it is assumed that these servers 101, 104, 106, 107 and the resources 201 being managed are interconnected by a single logical network 301. It is noted, however, that a physical network need not be a single network but may be divided into a plurality of sub-networks. Nor does it have to be homogeneous.

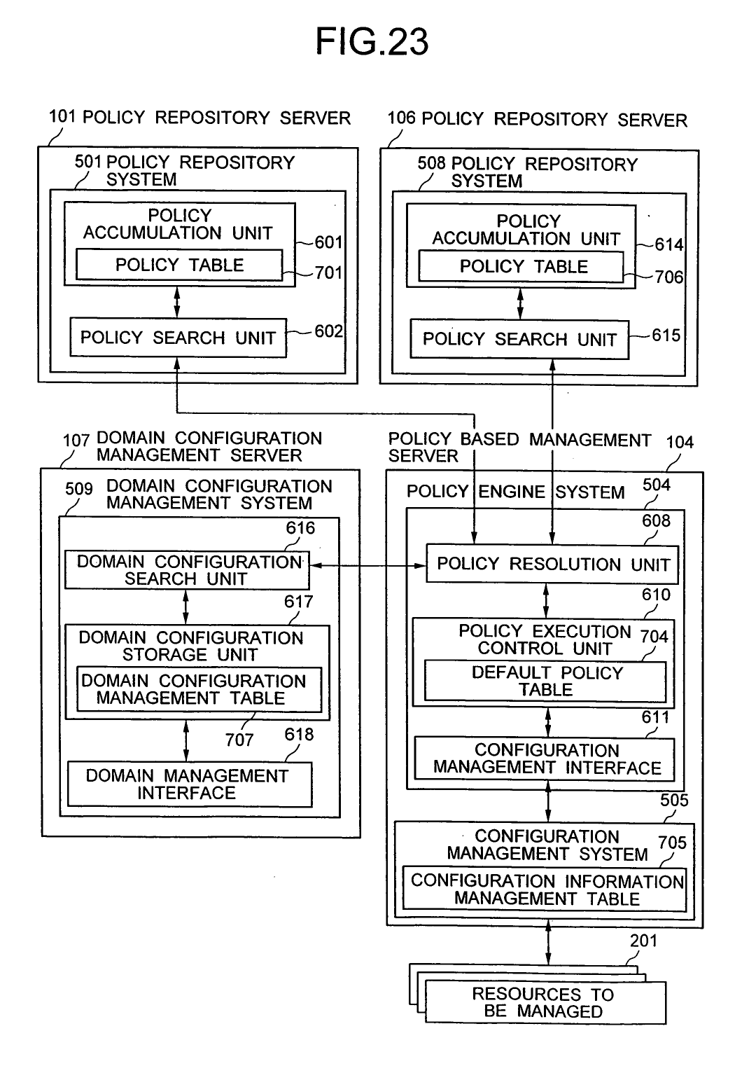

Next, a program configuration in each server will be explained by referring to FIG. 23. Operating on the policy repository server 101 in the business management domain 401 is a policy repository system 501 which includes a policy accumulation unit 601 and a policy search unit 602. Similarly, on the policy repository server 106 in the business management parent domain 405 is running a policy repository system 508 which includes a policy accumulation unit 614 and a policy search unit 615. In the domain configuration management server 107 a domain configuration management system 509 is operating which includes a domain configuration search unit 616, a domain configuration storage unit 617 and a domain management interface 618. On the policy based management server 104 in the data center domain 403, a policy engine system 504 and a configuration management system 505 are running. The policy engine system 504 includes a policy resolution unit 608, a policy execution control unit 610 and a configuration management interface 611.

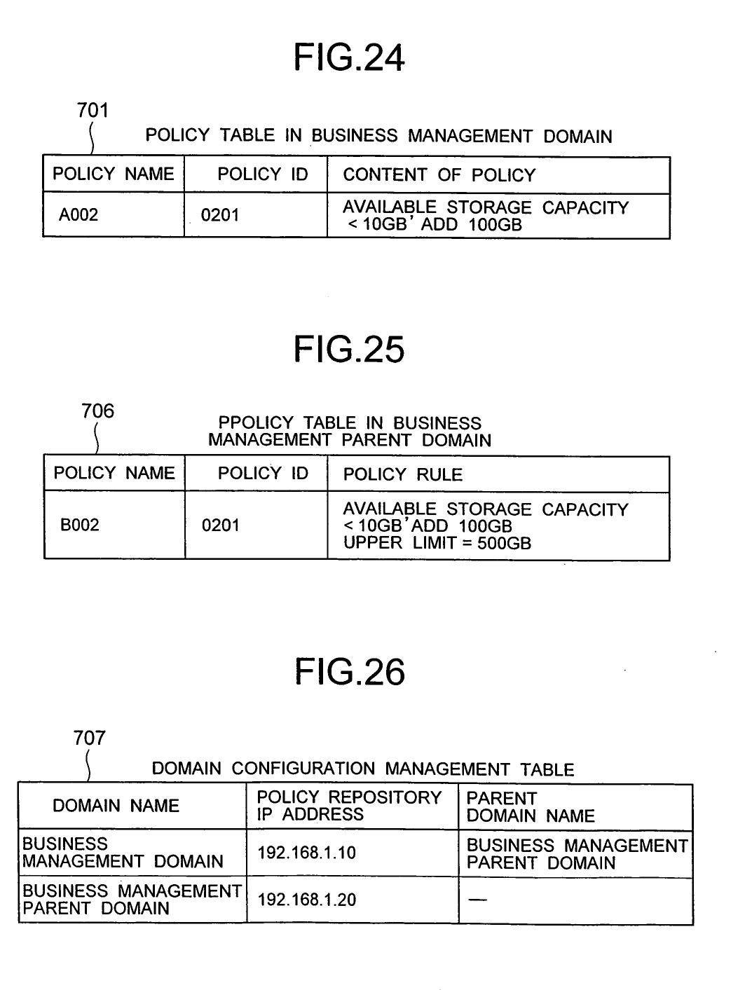

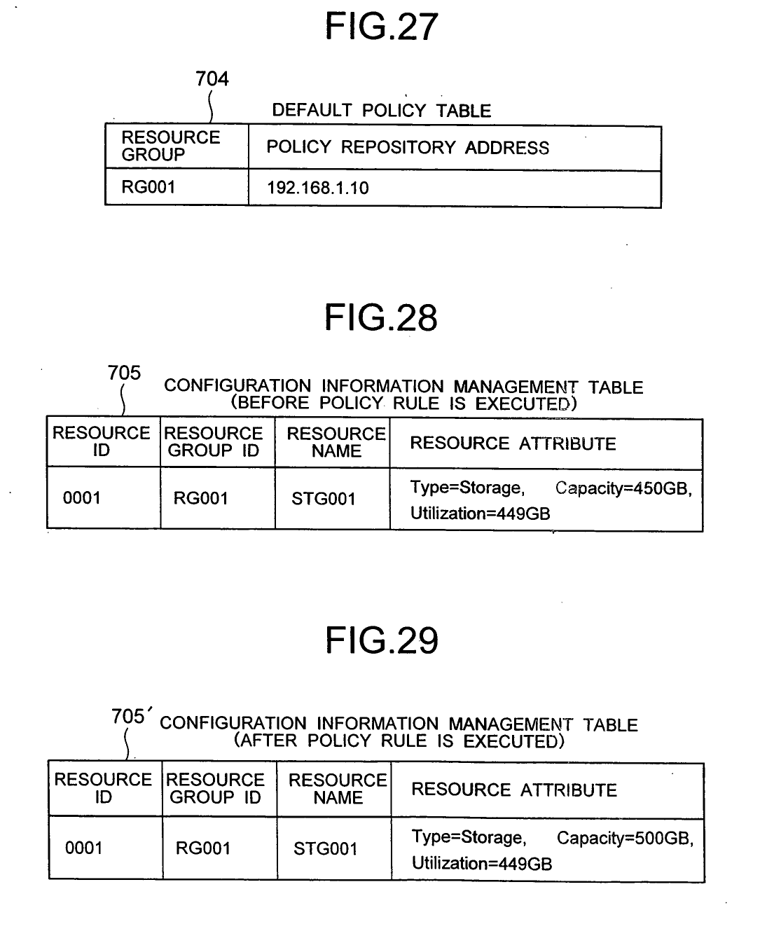

Further, a policy table 701 managed by the policy accumulation unit 601 stores a content shown in FIG. 24; a policy table 706 managed by the policy accumulation unit 614 stores a content shown in FIG. 25; a domain configuration management table 707 managed by the domain configuration storage unit 617 stores a content shown in FIG. 26; and a default policy table 704 managed by the policy execution control unit 610 stores a content shown in FIG. 27. It is assumed that detailed information on the resources 201 to be managed in the data center domain is stored in a configuration information management table 705 managed by the configuration management system 505 shown in FIG. 28.

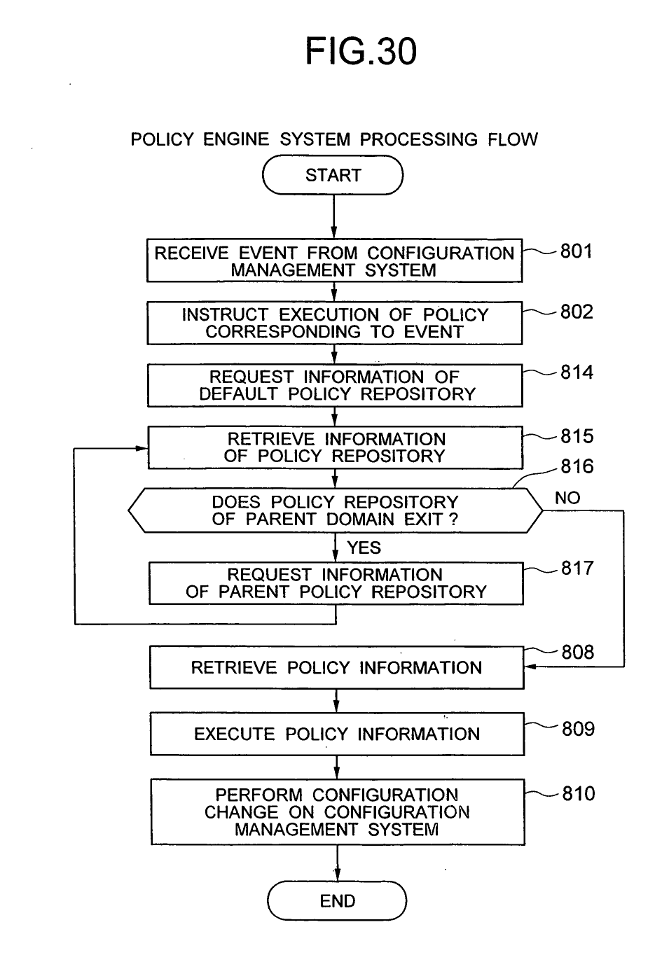

Under the above environment, an operation of the policy based management will be explained according to the processing flow of the policy engine system 504 shown in FIG. 30. First, of the resources 201 on which the business applications are running, a storage device with a capacity of 500 GB that corresponds to a resource ID of 0001 in the configuration information management table 705 of FIG. 28 is running low on its available capacity and sends to the configuration management system 505 an event message that the amount of disk space used has increased to 449 GB. At this time, a resource group ID that matches, one to one, the user of the storage device (in this case the business management domain) is also included in the event message. Further, the configuration management system 505 transfers the received event message to the policy execution control unit 610 through the configuration management interface 611 of the policy engine system 504 (step 801). The policy execution control unit 610 checks the content of the default policy table 704 to retrieve an IP address of the policy repository corresponding to the resource ID contained in the received event message. Here, the resource group ID is RG001, so the policy repository IP address retrieved is 192.168.1.10.

Next, the policy execution control unit 610 requests the policy resolution unit 608 to resolve a policy rule to be executed by using as input values the retrieved default policy repository IP address and the event message (step 814). The policy resolution unit 608 checks with the domain configuration search unit 616 of the domain configuration management system 509 as to whether there is a policy repository server in the business management parent domain that has an address of 192.168.1.10 (step 815). The domain configuration search unit 616 searches through the domain configuration management table 707 of FIG. 26 held in the domain configuration storage unit 617 and notifies the policy resolution unit 608 that a parent domain exists in the business management domain (step 816). Thus, the policy resolution unit 608 requests the domain configuration search unit 616 to search for information on the parent domain and retrieves 192.168.1.20 as a policy repository address of the business management parent domain (step 817). The policy resolution unit 608 also requests policy information corresponding to the event message from the policy search unit 615 of the policy repository server 106 in the business management parent domain and thereby retrieves policy information corresponding to a policy ID of 0201 in FIG. 25. In this case, policy information corresponding to a higher level domain exists. If the associated policy information is not found, policy information in a lower level domain is retrieved.

The policy information thus obtained in the above processing is transferred to the policy execution control unit where it is executed (step 809). As a result, the capacity of the storage device is increased and thus a request for an additional storage disk capacity is made to the configuration management system (step 810). The content of the configuration management table after the policy rule has been executed is as shown in FIG. 29, which indicates that the capacity of the storage disk belonging to the resource group RG001 has increased to 500 GB. (It should be noted that this capacity differs from 550 GB obtained when the policy rule of the business management domain is executed).

If a configuration is adopted in which the address of the policy repository in the parent domain that is obtained by the step 817 referring to the domain configuration management system 509 is stored in the policy resolution unit, the step 817 can be modified to make a search through the past query results prior to checking with the domain configuration management system.

### Embodiment 5

In this Embodiment, an operation of a policy configuration management system of this invention will be described for a case in which new policy information is created and registered with the policy configuration management system.

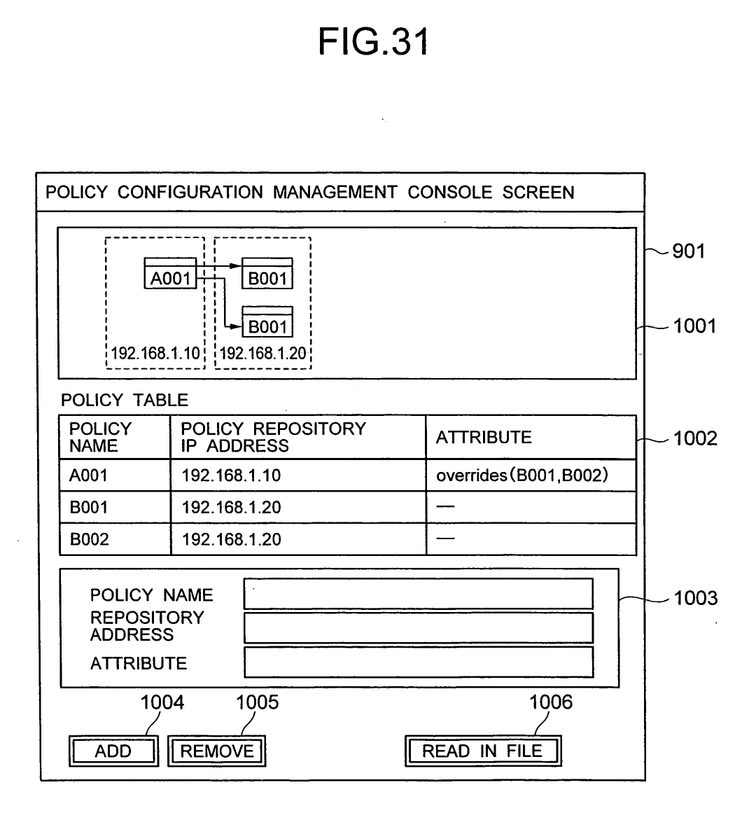

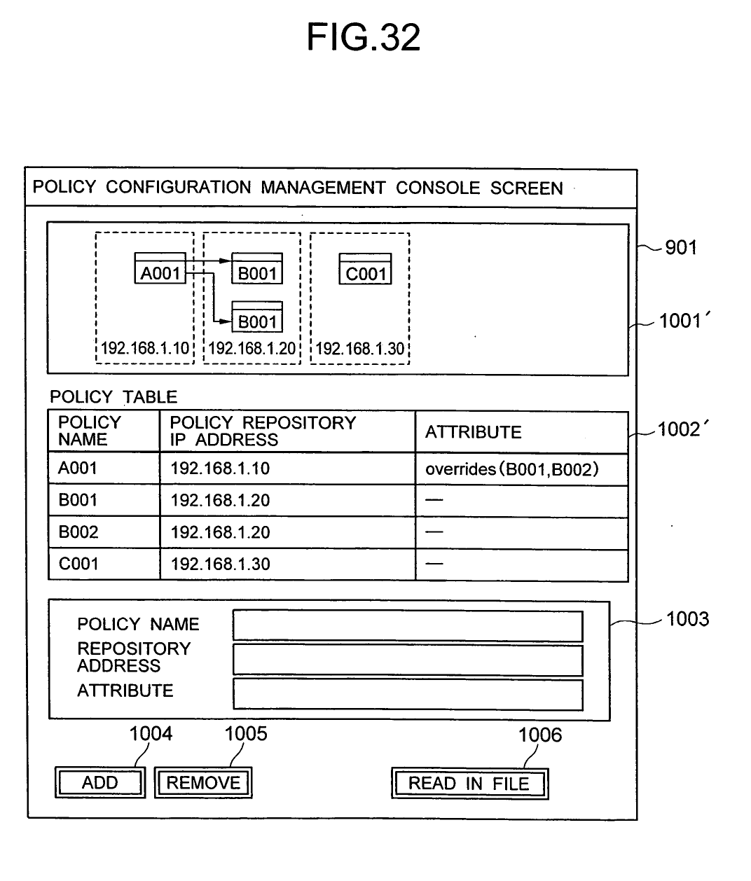

The system configuration and the program configuration are assumed to be similar to those of Embodiment 1 and are shown in FIG. 1 and FIG. 2, respectively. First, an administrator of registered policy information generates policy information to be registered with a policy repository server running in a domain to which the administrator belongs, such as a business management domain and a policy provider domain. A policy configuration management screen 901 shown in FIG. 31 appears when the user accesses a policy management interface 607 of the policy configuration management system 503 running on the policy configuration management server 103 from the policy repository server running on the domain to which the administrator belongs. This screen includes a policy configuration display area 1001, a policy table display area 1002, a policy information input unit 1003, a policy addition button 1004, a policy elimination button 1005, and a file read-in button 1006. The administrator inputs a policy name or an identifier of the policy information generated by the administrator and a policy repository address and, if necessary, an attribute into the policy information input unit 1003, and then presses the policy addition button 1004. This operation causes the policy configuration management system to retrieve a policy name of the new policy information, a policy repository address and an attribute and store them in the policy configuration management table 703. The result of this operation can be checked from the policy repository server running in the domain to which the administrator belongs. That is, the content of the updated policy configuration management table 703 is displayed on the policy configuration display area 1001 and the policy table display area 1002. A screen or page updated when a policy with a policy name of C001 is added is shown in FIG. 32.

To execute the policy based management as described in Embodiment 2 by using both a policy and an overriding policy managed in another domain, it is required that, when registering the policy name of the overriding policy and the address of the repository, the policy be an overriding policy and that information that links the overriding policy with the name of a policy to be overridden be registered in an attribute column in the policy configuration management table. By inputting the information in the attribute column on the policy configuration management screen 901 by the policy information input unit 1003, the link information is registered. The relation between the overriding policy and the overridden policy that is registered with the policy configuration management table is displayed on the policy configuration display area 1001.

In the policy table display area 1002, selecting desired policy information and pressing the policy elimination button 1005 can erase the corresponding policy. Further, by reading in a file of a desired description format using the file read-in button 1006, policy information can be changed en masse.

### Embodiment 6

In this Embodiment, an operation of a domain configuration management system will be described for a case in which a policy repository corresponding to a newly created domain is installed and in which domain information on the domain configuration management system as disclosed in this invention is registered.

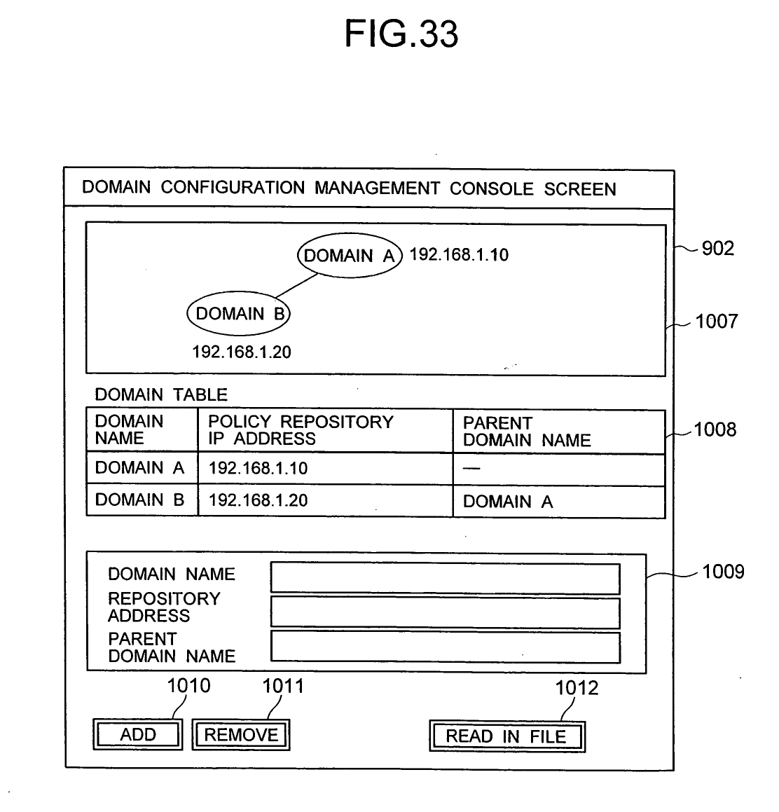

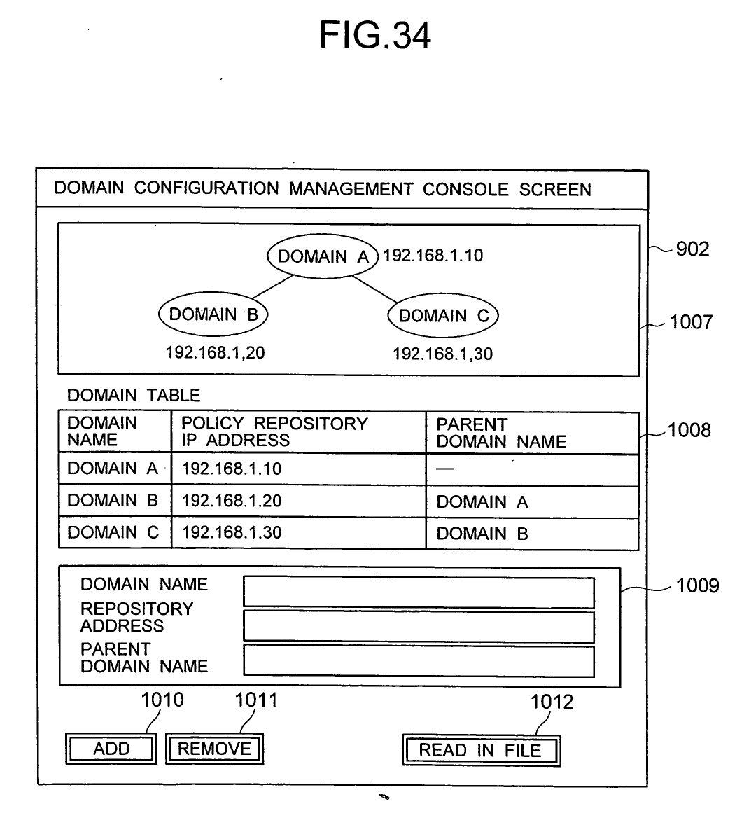

The system configuration and the program configuration are assumed to be similar to those of Embodiment 4 and are shown in FIG. 22 and FIG. 23, respectively. First, an administrator of registered domain information puts into operation a policy repository server that the administrator wishes to register with a domain to which the administrator belongs. A domain configuration management screen 902 shown in FIG. 33 appears when the user accesses a domain management interface 618 of the domain configuration management system 509 running on the domain configuration management server 107. This screen includes a domain configuration display area 1007, a domain table display area 1008, a domain information input unit 1009, a domain addition button 1010, a domain elimination button 1011, and a file read-in button 1012. The administrator inputs a domain name of the domain installed by the administrator, a policy repository address where the policy of the domain is stored, and a parent domain name into the domain information input unit 1003, and then presses the domain addition button 1004. This operation causes new domain information to be saved and the domain configuration display area 1007 and the domain table display area 1008 to be updated.

In the domain table display area 1008, selecting desired domain information and pressing the domain elimination button 1011 can erase the corresponding policy. Further, by reading in a file of a desired description format using the file read-in button 1012, domain information can be changed en masse.

The distributed policy linking method of this invention is applicable to the following industrial fields:

Policy Based Management System in Data Center

In a data center, when business applications are operated and managed by a policy base, a business application developer does not have to write all policy information for running the business applications. Of the policy information for the business applications, those of general functions are prepared beforehand in the data center and the developer of the business applications need only write a part that is unique to the applications by using a policy library. The application of this invention makes it easier to generate a library of policies for running applications, improving the reusability of policies.

Policy Based Management System in Corporate IT System

In a policy based management in a corporate IT system, policy information needs to be linked among departments or offices and branches represented by management domains in an enterprise. With this invention, policies can be linked among different management domains in an enterprise, helping to reduce the cost of policy based management in a corporate IT system.

It should be further understood by those skilled in the art that although the foregoing description has been made on Embodiments of the invention, the invention is not limited thereto and various changes and modifications may be made without departing from the spirit of the invention and the scope of the appended claims.

1. A distributed policy linking method to resolve an association between policy information in a system where a plurality of policy repositories each holding policy information are distributed among management domains in a network, the distributed policy linking method comprising the steps of:
installing a policy configuration management system to manage an association between policy information held in each policy repository and a means for accessing the policy repository;
retrieving first policy information stored in a first policy repository;
when the first policy information retrieved specifies as a reference destination an identifier of policy information stored in another policy repository, referring to the policy configuration management system for an access means to access a second policy repository corresponding to the identifier; and
accessing the second policy repository by using the access means acquired by the referring-to to retrieve second policy information.

2. A policy based management method in a system in which a plurality of policy repositories each holding policy information and a configuration management system to manage a configuration of resources according to a plurality of pieces of policy information are distributed in management domains on a network, the policy based management method comprising the steps of:
installing a policy configuration management system that manages a set of an identifier of each policy information and each policy repository;
when the configuration management system receives an event issued from a resource being managed, retrieving first policy information corresponding to the received event from a first policy repository;
when the retrieved first policy information includes reference information representing a reference to another policy repository, referring to the policy configuration management system for an access means to a second policy repository indicated by the reference information;
accessing the second policy repository by using the access means acquired by the referring-to to retrieve second policy information; and
according to the policy information acquired, executing a configuration modification operation on the resources being managed.

3. A policy based management method according to claim 2, wherein the reference information included in the first policy information represents a delegation of a policy to the second policy repository and a policy based management is performed by using the policy information included in the second policy repository in place of the first policy information.

4. A policy based management method according to claim 2, wherein the reference information included in the first policy information indicates an existence of another policy information to overwrite the first policy information and a policy based management is performed by using a policy that is acquired by partly overwriting the first policy information with the second policy information.

5. A distributed policy linking method according to claim 1, further including the step of:
storing the access means to the second policy repository acquired by the reference;
wherein, when the retrieved policy information specifies as a reference destination an identifier of the policy information stored in another policy repository, past stored query results are searched first prior to referring to the policy configuration management system.

6. A distributed policy linking method according to claim 1, further including the steps of:
retrieving an identifier of newly created policy information and an access means to the policy repository holding the policy information; and
storing them as a set in the policy configuration management system.

7. A distributed policy linking method to resolve an association between policy information in a system where a plurality of policy repositories each holding policy information are distributed among management domains in a network, the distributed policy linking method comprising the steps of:
installing a domain configuration management system to manage an association between an address of a policy repository in each management domain and the policy repository;
retrieving an address of a first policy repository holding the policy information associated with a resource in which an event has occurred;
referring to the domain configuration management system to determine whether there is a second policy repository at a level higher than the first policy repository;
when the second policy repository exists, retrieving an address of the second policy repository from the domain configuration management system; and
retrieving policy information to be applied to the resource by accessing the second policy repository.

8. A distributed policy linking method to resolve an association between policy information in a system where a plurality of policy repositories each holding policy information are distributed among management domains in a network, the distributed policy linking method comprising the steps of:
installing a policy configuration management system to manage an association between policy information held in each policy repository and a means for accessing the policy repository and to manage an overwriting relation between policy information; and
retrieving first policy information stored in the first policy repository;
when the first policy information has an attribute indicating that the first policy information can be overwritten with other policy information, requesting the policy configuration management system to search for second policy information to overwrite the first policy information and a means to access a second policy repository storing the second policy information; and
acquiring the access means to the second policy repository retrieved by the search and accessing the second policy repository to retrieve the second policy information.

9. A distributed policy linking method according to claim 7, further including the steps of:
when new policy information to overwrite the existing policy information is created, retrieving an identifier of the new policy information, the access means to the policy repository having the new policy information, and an identifier of the existing policy information to be overwritten, and storing them as a set in the policy configuration management system.
